(19) United States
(12) Patent Application Publication
(10) Pub. No.: US 2024/0411658 A1
(43) Pub. Date: Dec. 12, 2024

(54) Large Artificial Intelligence Model Prediction and Capacity

(71) Applicant: Microsoft Technology Licensing, LLC, Redmond, WA (US)

(72) Inventors: Sanjay RAMANUJAN, Sammamish, WA (US); Karthik RAMAN, Sammamish, WA (US); Rakesh KELKAR, Bellevue, WA (US); Pei-Hsuan HSIEH, Bellevue, WA (US)

(73) Assignee: Microsoft Technology Licensing, LLC, Redmond, WA (US)

(21) Appl. No.: 18/208,192

(22) Filed: Jun. 9, 2023

(51) Int. Cl. G06F 11/34; G06Q 30/0283

(52) U.S. Cl. CPC G06F 11/3414; G06Q 30/0283

(57) ABSTRACT

This document relates to predicting performance of large artificial intelligence (LAI) models that are too large to be handled by a single computing device. One example can receive a sample workload for a trained LAI model and identify multiple nodes functioning as a cluster to instantiate an instance of the trained LAI model. The example can predict performance characteristics for accomplishing the sample workload on the cluster and can cause at least some of the predicted performance characteristics to be presented on a user interface.

### BACKGROUND

Large artificial intelligence (AI) models, such as generative transformer models including large language models, are proficient at providing accurate responses to queries (e.g., prompts). However, resource usage associated with generating these accurate responses is not well understood.

### SUMMARY

This patent relates to predicting the performance of large artificial intelligence (LAI) models that are too large to be handled by a single computing device. One example can receive a sample workload for an LAI model and identify multiple nodes functioning as a cluster to instantiate an instance of the trained LAI model. The example can predict performance characteristics for accomplishing the sample workload on the cluster and can cause at least some of the predicted performance characteristics to be presented on a user interface.

Another example can receive a sample workload for a trained LAI model that is spread across multiple nodes. The example can identify a first hardware configuration that can include the multiple nodes and a second hardware configuration that can include the multiple nodes. The example can predict performance characteristics for accomplishing the sample workload with the first hardware configuration and the second hardware configuration. This example allows for the comparison of different hardware configurations for present and/or future workloads.

This Summary is intended to introduce some of the present concepts described in this patent and is not intended to be limiting or all-inclusive of the novel concepts.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIGS. 1A, 1B, 2, 3, and 7 illustrate example systems that can implement LAI model resource prediction concepts consistent with some implementations of the present concepts.

FIGS. 5A and 5B show example dashboards that are consistent with some implementations of the present concepts.

FIG. 4 illustrates an example graph that is consistent with some implementations of the present concepts.

FIG. 6 illustrates an example flowchart that is consistent with some implementations of the present concepts.

### DETAILED DESCRIPTION

### Overview

The present concepts relate to employing artificial intelligence (AI) models in datacenters, such as on cloud computing artificial intelligence (AI) platforms. Cloud computing AI platforms, such as Microsoft's Azure AI Platform and Amazon's AWS, are built to leverage cloud resources including large data centers that include many (e.g., thousands) physical computing devices (e.g., hardware). The physical computing devices can include compute resources, such as memory, storage, central processing units (CPUs), graphic processing units (GPUs) and/or other specialized processors, such as processors that are proficient at performing matrices operations, etc.

Cloud computing AI platforms support large artificial intelligence (large AI or LAI) models. As used in this document, LAI models are AI models that are too large to be handled by a single node. The cloud computing AI platforms can make the large AI models accessible via application programming interface (API) calls and in some cases cause the large AI models to be governed by a responsible AI layer. The cloud computing AI platforms can allow entities (e.g., customers) to create their own LAI models and/or use existing LAI models provided by the cloud computing AI platforms. In some cases, the entities can bring their own data for training and/or inferencing the LAI models.

Large AI models can include large generative transformer (LGT) models for vision, speech, language, and decision making, among others. Entities can deploy state-of-the-art (SOTA) LAI models, such as LGT models, such as Large Language Models (LLMs), speech models, image models, various multimodal models, including traditional machine learning models. Large AI models can also include diffusion models (i.e., text-to-image models), video generation models (from text input), music generation models (from text input), and/or plugin extension models for LLMs (i.e., models that use 3rd party services to provide real time data), among others.

Entities can access compute resources and shape their workload based on their business needs and cost while ensuring infrastructure redundancy. Answering queries (e.g., prompts) with large generative transformer models tends to proportionally utilize large amounts of specialized processing (e.g., GPUs) and thus this compute resource is emphasized below. However, the present concepts also apply to other types of compute resources.

The cloud computing AI platforms offer service elasticity to meet any shape and form of entities' GPU demand. However, GPU capacity is not infinite and is a shared resource accessible by multiple entities. Hence an effective way to estimate performance, such as throughput and latency, based on entity provided workload will determine the concurrency they can use, and the capacity required to keep costs low for entities and cloud computing AI platforms while allowing for seamless scale use of LAI models including large generative transformer models. The present concepts provide a technical solution to this performance estimation problem.

Large AI models, such as large generative transformer (LGT) models continue to increase in size. As used in this document, a large AI model is defined as any model that is too large for a single node and is instantiated across multiple nodes. For instance, many LGT models such as GPT3 (Generative Pre-trained Transformer 3), OPT (Open Pretrained Transformer), and BLOOM have more than 100B parameters. Generative AI involves using pretrained LGT models, such as neural network (NN) models with the ability to create realistic text, images, music, or other types of media. Cloud computing AI platforms that support LGT models have been launched that enable developers to easily adapt LGT models and deploy customized AI applications for content generation, text summarization, classification, chatbots, code development, as well as protein structure and biomolecular property predictions, among others. These services make LGT model training and inference easy and reproducible on a wide range of GPU cluster configurations.

However, supporting LAI models, such LGT models with cloud computing AI platforms faces several technical challenges. The first of these technical challenges relates to scalability. The LGT models are immense and don't fit on a single node. As used here, a ‘node’ means the compute resources of a single physical computer. As mentioned above, the focus of this description is GPUs, but the description is equally applicable to other compute resources. A node may include one or more GPUs. For instance, many servers now include 4-48 GPUs. A ‘cluster’ is a group of physical or virtual machines working together to handle an instance of an individual LAI model. The instance of the LAI model can handle a given number of queries/prompts (having a set of properties) at a given rate. The scalability factor contributes to cost and scarcity considerations. Stated another way, the entity may not want to pay for additional nodes and/or clusters for more model instances and thus may not receive the desired performance.

The next technical challenge relates to speed (e.g., speed at which answers are generated by the LAI models, such as LGT models, responsive to user queries). The LGT models generate one token at a time, and speed is noticeable, especially in streaming mode. Large models have many layers including a mixture of experts that enable high quality output. Balancing quality over speed becomes a balancing act and is a constant business challenge.

The next technical challenge relates to usability. It is not sufficient to have just an API for large LGT models, entities (e.g., customers) should have the option to further fine-tune the LGT model for a specific scenario.

The next technical challenge relates to responsible AI (RAI) protocols. The model output needs to follow RAI protocols to ensure safety for both the consumer and entity (e.g., business) that arise from the challenges of using AI content.

The next technical challenge relates to hallucinations. With AI, the LGT models can generate data that does not exist in the real world or in its underlying training data. This generates seemingly correct and factual sounding statements but there are random falsehoods in the generated content. This poses challenges for consumers and entities to discern true information when relying on content arising from generative LGT models.

The above-mentioned challenges are immense and are addressed differently by different LAI models. Some of the inventive concepts address computer usage associated with different LAI models. First, given a sample customer workload (with a certain distribution of input and output tokens), the inventive concepts predict performance for the workload, i.e., the optimal throughput (scale) and latency curves (performance) that can be achieved with an individual LAI model. Second, the present concepts provide the ability to predict compute resource (e.g., GPU) capacity requirements to achieve the desired SLA policy. Third, the present concepts offer the ability to compute cost from these performance curves and forecast pricing and/or hardware needs for the entity. Collectively, this aspect can also aid in managing the cloud computing AI platforms in relation to total size (e.g., total number of devices) and/or hardware ratio (e.g., hardware specification of individual machines). Fourth, the present concepts offer the ability to abstract physical resources and networking topology to determine performance characteristics of LAI models. Fifth, the present concepts offer a recommendation system consisting of a matrix of LAI models, hardware stock keeping units (SKUs), quality of results in the desired region (e.g., datacenter closest to geographical location where workload originates) to achieve a stated SLA with the performance-scale goals and pricing sensitivity. Sixth, the present concepts offer the ability to understand the impact of different workloads on these LAI models without conducting extensive benchmarking or proof of concepts to get a rapid understanding of performance-scale cost. Seventh, the present concepts offer the ability to model additional sensitivity analysis by adding information (such as expected cache hit rate, prompt customization etc.) that influences the token generation rate. Eighth, the present concepts offer an intelligent system that can determine the ideal LAI model and compute resource (e.g., GPU) cluster configuration to run a workload without human intervention.

The present concepts can predict performance of LAI models and their associated capacity to hit customer SLA requirements using high performance compute resources (e.g., cloud-based resources). The inventive concepts include technical solutions for predicting performance and capacity modeling cloud computing AI platforms. The technical solution can utilize characteristics of transformer models for token generation, a solution architecture to load LAI models into memory, determine concurrent requests that can safely operate with guaranteed throughput-latency results and meeting stated SLA objectives.

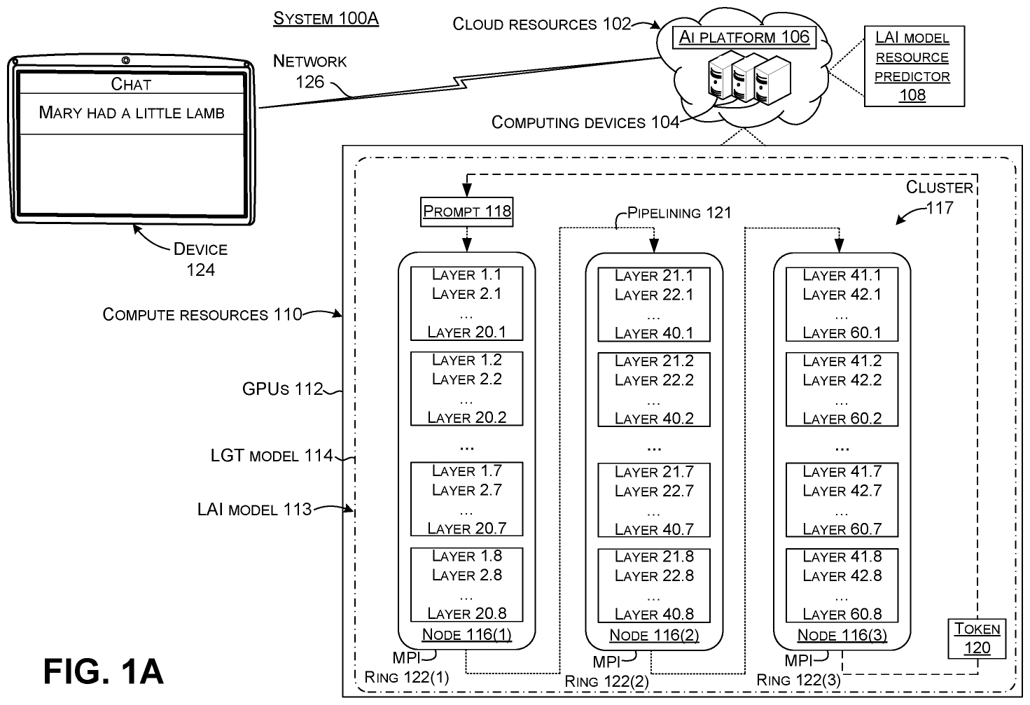

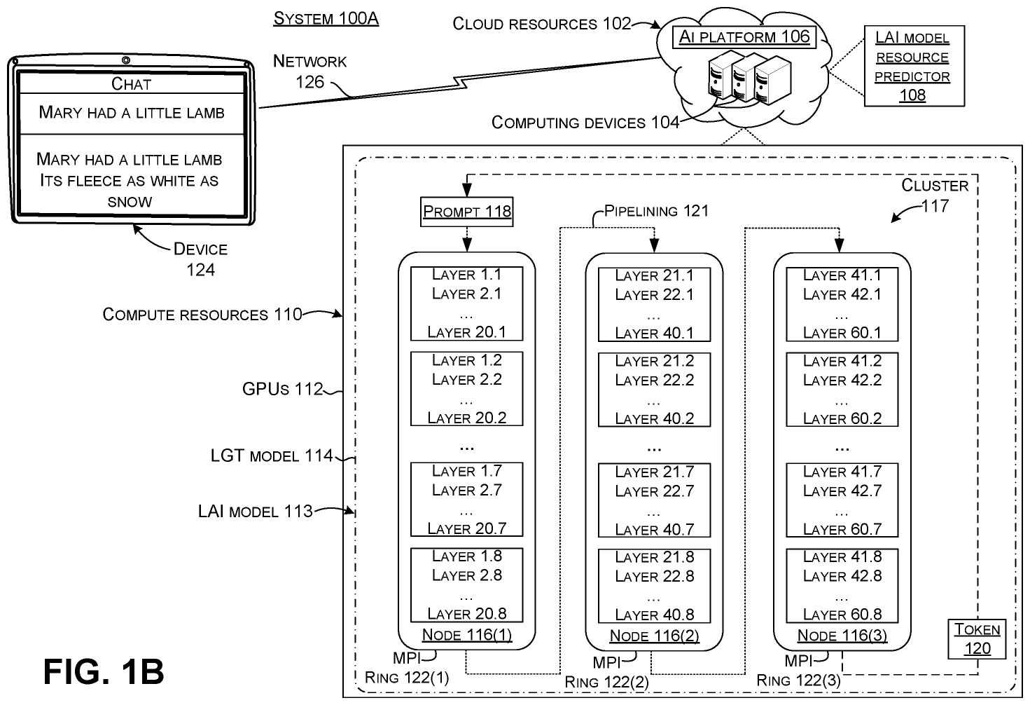

Introductory FIGS. 1A and 1B collectively show an example system 100A, which can implement the present LAI resource prediction concepts. System 100A includes cloud resources 102 that entail multiple computing devices (e.g., servers) 104. The cloud resources 102 provide an AI platform 106. The cloud resources 102 also include and/or interact with an LAI resource predictor 108. The computing devices 104 contribute compute resources 110, such as GPUs 112, CPUs, memory, storage, etc. A given combination of compute resources may be referred to as a stock keeping unit (SKU).

The compute resources 110 support an instance of an individual LAI model 113. In this case, the LAI model 113 is an LGT model 114 (e.g., the LGT model 114 is instantiated on the compute resources 110). Compute resources 110, such as GPUs 112, are organized into nodes 116 to execute the LGT model 114. The three nodes 116(1)-116(3) that instantiate an instance of the LGT model 114 can be viewed as a cluster 117.

In this example, each node 116 includes 20 layers. Other numbers of nodes and/or layers are contemplated. Node 116(1) receives prompts 118. The output of node 116(1) is directed as input to node 116(2). Similarly, the output of node 116(2) is directed as input to node 116(3), which generates a token 120. The tokens 120 are directed as input prompts back into node 116(1). This output to input configuration (e.g., the output of node 116(1) serves as input to node 116(2) and the output of node 116(2) serves as input to node 116(3)) can be referred to as pipelining 121.

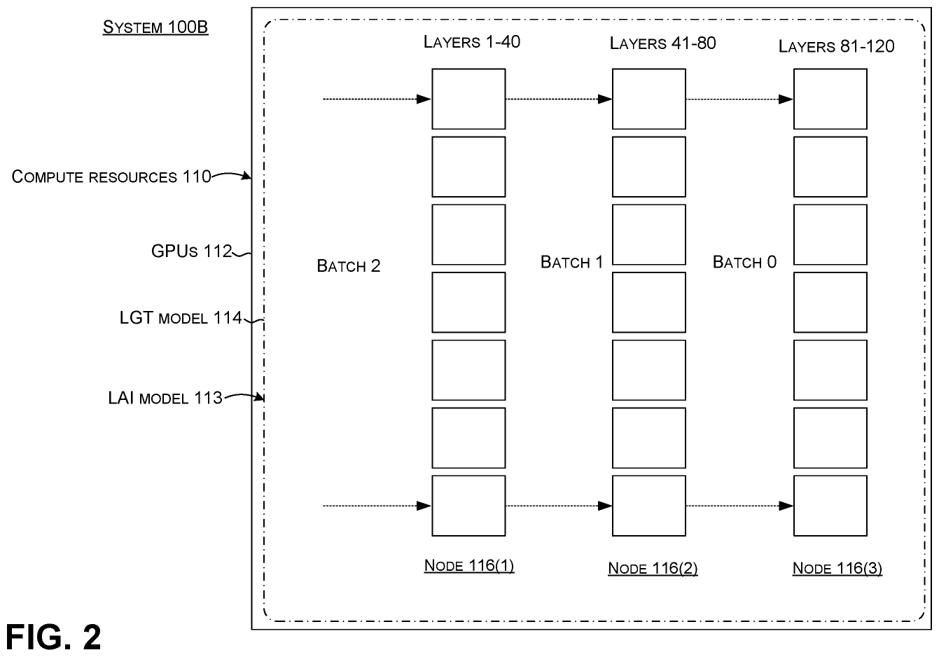

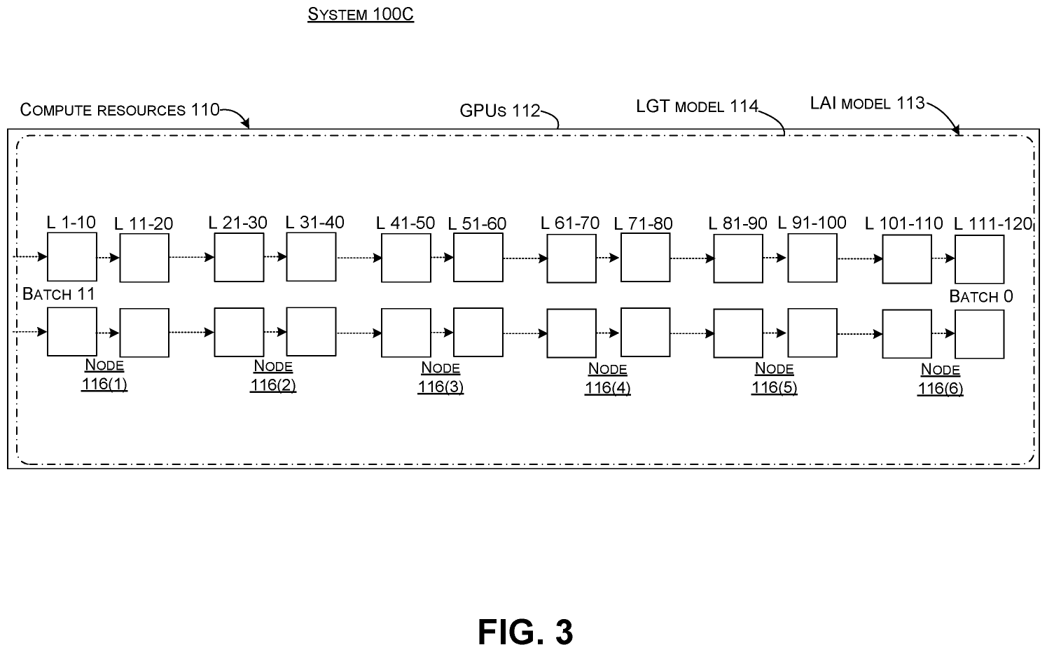

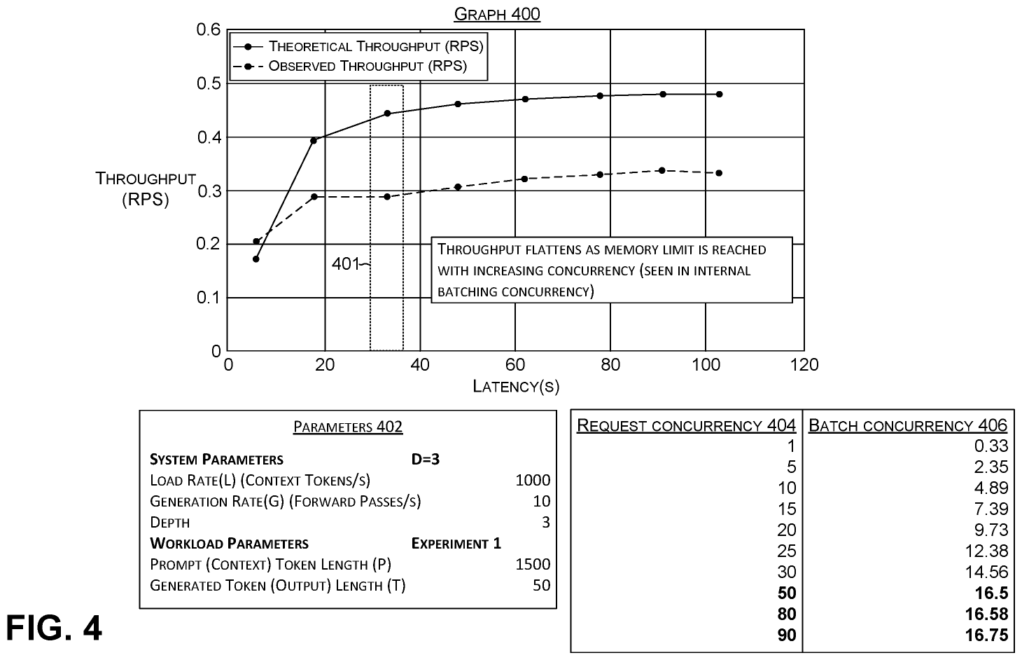

In this example, the compute resources 110 that hosts a single LGT model instance with 60 layers is manifest as a hardware configuration that includes three A100 NDm 80 GB nodes with depth=3, shard=8 and 24 GPUs. The number of such multi-nodes that support a single model instance is referred to as depth. Note, there can be different hardware SKUs that support different configurations (aka depth) based on LGT models. Two more example compute resource configurations (e.g., different hardware SKUs) are shown in FIGS. 2 and 3. Other hardware SKUs are contemplated that support different LGT model configurations with different performances and the underlying principles remain the same.

As mentioned above, LGT model performance predictions are complicated by the size of the LGT models 114. LGT models are large and do not fit in the available memory of a single node 116. To run effectively on the AI platform 106, the LGT models 114 are pipelined to fit on multiple nodes 116 which communicate utilizing a parallel processing program (PPP) that creates a ring of communicative processes (e.g., each node is connected to only two other nodes). As used here, ‘pipelined’ and ‘pipelining’ means the output of one individual node is fed as input into the next individual node. In this example, the parallel processing program is manifest as message passing interface (MPI) rings 122.

For purposes of explanation, a use case scenario is now described. Assume that an end user accesses the LGT model 114, such as via a chat interface on computing device 124 over network 126. In FIG. 1A the user enters a prompt that includes the words ‘Mary had a little lamb’ for inference. The words ‘Mary had a little lamb’ are converted to tokens and run through the LGT model 114 as prompt 118. The LGT model generates a token 120 (e.g., a word) and adds the token to the tokens received from the user and re-runs through the LGT model 114 until complete (e.g., until a stop logic condition is met). The response is then presented to the user on the computing device 124 as shown in FIG. 1B. In this example the response is ‘Mary had a little lamb its fleece as white as snow.’

This use case scenario can be viewed as representative of an expected workload. The LAI resource predictor 108 functions to predict the performance of the LGT model for given types and volumes of workload. Stated another way, for a given workload (e.g., number and type of uses per unit time), a given hardware configuration, and given LGT models, the LAI resource predictor 108 can predict the expected performance. In this case, the performance relates to latency and/or throughput, among other parameters. Latency represents the delay between receiving the user input and the LGT model generating the output. Throughput relates to how many requests can be generated per unit time. The LAI resource predictor 108 makes the prediction based upon the size of the sample workload per unit time, the compute resources 110, and the LGT model 114, among other factors. The predictions allow the entity to make informed decisions related to cost and performance in light of what the end user (e.g., the entity's customer) will experience when they use the LGT model as part of their interactions with the entity.

Note that for purposes of explanation the present description relating to FIGS. 1A and 1B shows an end user query/prompt and the associated hardware/LGT model response. In practice, many of the present concepts relate to interactions between the entity (that the end user interacts with) and the cloud resources provider that occur before the end user is involved to enhance the end user experience when it subsequently happens.

Thus, an entity can use the LGT model prediction to have a better understanding of the end user experience, the ability to satisfy the SLA, and/or the performance offered by differing amounts and/or types of hardware. This allows the entity to have an accurate understanding of the use case scenario introduced above. To summarize, once the end user issues a prompt for inference, the entity flow includes the following aspects in relation to operation of the LGT model 114 on the compute resources 110. First, the technique takes the prompt input as a string and then generates tokens for matrix computations (both operations in CPU). Next, the technique determines the cache hit rate and gets prior generated tokens via a lookup and then sends remaining prompt tokens to the GPUs in the cluster. The technique generates a token (one at a time) and then appends this to the prompt and continues token generation until a stop logic condition is met (all operations in the GPU).

The technique then converts the tokens to a string and sends the output to the end user (in the CPU). If an entity requests streaming, then each token is sent as it is generated. Otherwise, the entirety of the tokens is sent once they are generated in batch mode.

In the above architecture, an incoming prompt is delivered to the first node 116(1). The GPUs on this node perform matrix operations to compute the token from the first 20 layers. The output of the first node 116(1) is then connected to the second MPI ring 122(2) for the next set of operations and then eventually enters the third MPI ring 122(3). The final output token 120 is appended to the original request prompt 118, and this is then used to generate the next token set. LGT models generate one token at a time and append the result to get the next token and so on. Different hardware configurations (e.g., different node configurations) are going to provide different performance with different LGT models and workloads. The present concepts offer a technical solution that can predict those performances.

FIGS. 2 and 3 show two additional pipeline configurations in systems 100B and 100C, respectively. FIG. 2 shows compute resources 110 that include GPUs 112 of three nodes 116(1), 116(2), and 116(3). For example, the compute resources can entail hardware comprising A100 ND 40 GB, d=6, shard=8, with 48 GPUs and/or A100 NDm 80 GB, d=3, shard=8, with 24 GPUs, among others. The LGT model 114 is distributed across the nodes 116. Each node entails 40 layers. The maximum number of concurrent batches supported by this pipelined configuration is three with a depth of three.

FIG. 3 shows compute resources 110 that entail GPUs 112 in six nodes 116(1)-116(6). In this example, the compute resources can entail hardware comprising NCv4 (4 A100 80 GB with PCIe) Standard_NC48ads_A100_v4 (NC A100 80 GB). This implementation can also have a hardware configuration that includes A100 NCv4 440 GB, d=12, shard=2, 12 GPUs, among others. The LGT model 114 is distributed across the nodes 116. Each node entails two pipelined 10-layer sets of the LGT model for a total of 120 layers. Thus, as an initial batch 0 has processed through all of the nodes to node 116(6), subsequent batches are being processed by intermediate layers and an 11th batch is being received by layers 1-10 in the first node 116(1).

The example compute resource configurations described relative to FIGS. 1A and 1B, 2, and 3 are intended to illustrate that the present LAI resource prediction concepts work with various pipelined hardware configurations where the LAI model is split across multiple devices. For instance, each of these example hardware (e.g., compute resource) configurations can have a different latency, throughput, and/or cost for a given LAI model. For purposes of explanation, in the examples of FIGS. 1A-3, the LAI model is an LGT model. The LAI model resource prediction concepts apply to other LAI models.

The present techniques can determine performance characteristics (e.g., throughput and latency) for a given LAI model, such as an LGT model on given hardware (e.g., compute resource) at a given workload by ascertaining the following aspects. First, the techniques can identify incoming concurrency which drives throughput and latency. Concurrency can be understood as the number of parallel requests made to the LGT model. However, GPU memory is finite. Thus, there is a memory cap on concurrency. Any concurrency beyond the memory cap will only impact latency as throughput does not improve or only marginally improves beyond this point. The techniques can determine the potentially ideal concurrency spot or range for every workload (wide distribution of input and output tokens) for every SKU to maximize throughput and run at optimal latency. An example throughput latency formula to tie this together for this set up is provided below.

Throughput latency formula.

$$Latency ( l ) = Load Time + Generation {Time}_{( seconds )}$$

$$\text{} \begin{matrix}Load Time = Total {Prompt}_{( Tokens )} / Load {Rate}_{( Tokens / s )} {\text{=>}}_{( seconds )} \\ = Prompt Length {( P )}_{( Tokens / Request )} * \\ {Concurrency}_{( Requests / Box )} * \\ {Depth}_{( Boxes )} / Load Rate {( L )}_{( Context Tokens / s )} \\ = PCD / {L}_{( seconds )}\end{matrix}$$

$$\text{} \begin{matrix}Generation Time = Token {Length ( T )}_{( Tokens )} / Generation {Rate ( G )}_{( Tokens / s )} \\ = T / G ( seconds )\end{matrix}$$

$$Latency ( l ) = PCD / L + T / {G}_{( seconds )}$$

$$\text{} \begin{matrix}Output Generated = Token {Length ( T )}_{( Tokens / Request )} * \\ {Concurrency ( C )}_{( Requests / Box )} * {Depth}_{( Boxes )} \\ = TC\end{matrix}$$

$$\text{} \begin{matrix}Throughput ( TP ) = Output Generated / Latency ( l ) \\ = TC / l\end{matrix}$$

$$RPS = C * D / l$$

Load Rate (L) and Generation Rate (G) are determined via prior simulations and these coefficients are independent of the customer workload (i.e., distribution of context and generated tokens) and made available for capacity modeling. An example experiment is shown directly below.

Inputting the information from the latency formula above provides a throughput-latency curve for the given workload. The throughput-latency curve provides an estimate of the optimal throughput at which latency can be driven. Any concurrency beyond this level will hit the GPU memory limit and does not help improve throughput and will degrade latency.

FIG. 4 shows a graph 400 of throughput over latency (e.g., throughput-latency curve). The graph shows an optimal performance zone 401 that balances these aspects. This zone represents the transition where throughput flattens while latency continues to increase. FIG. 4 also shows parameters 402 associated with the graph 400. FIG. 4 further shows various values for request concurrency 404 and batch concurrency 406.

Graph 400 is the result for a single LAI model instance that operates on an entity workload with a latency of 60 seconds with a throughout of 0.3 responses per second (RPS). To get to a latency of three RPS requires ten such model instances to be deployed together (e.g., each model instance produces 0.3 RPS multiplied by 10 model instances produces 3.0 RPS). Similarly, if a lower latency of 20 seconds is desired, the throughput is 0.2 RPS, hence 15 model instances (e.g., =3/0.2) will be employed to hit this desired service level agreement (SLA).

The GPU cost and cost-per-token can be readily computed based on the SLA and perf-scale results. For instance, cost can be associated with the overall hardware, and various overhead costs and computing the cost-per-token from those values.

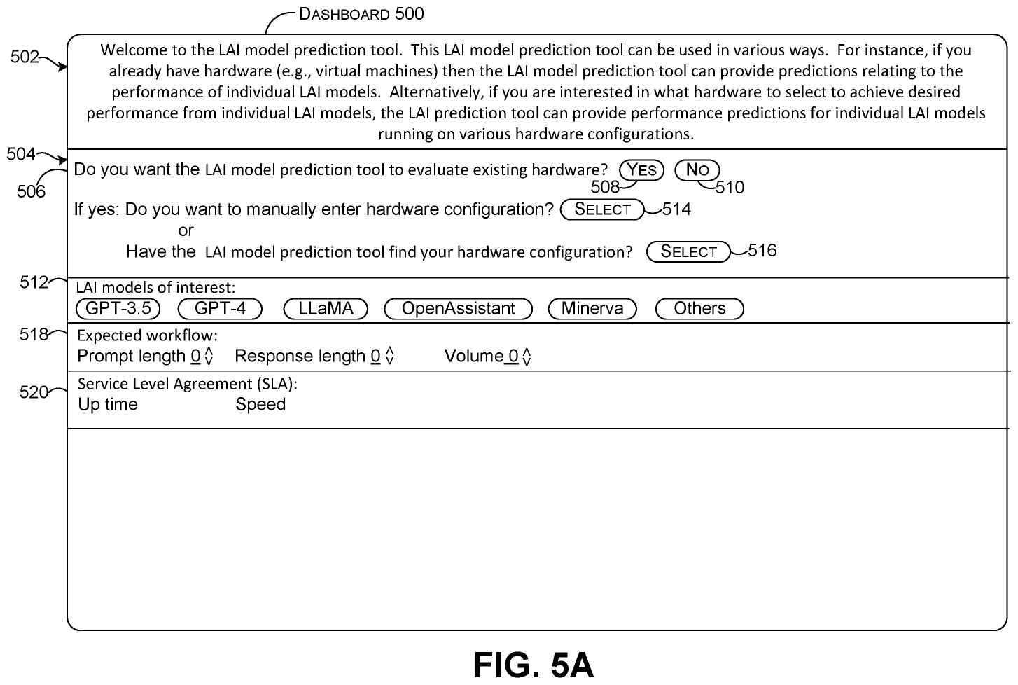

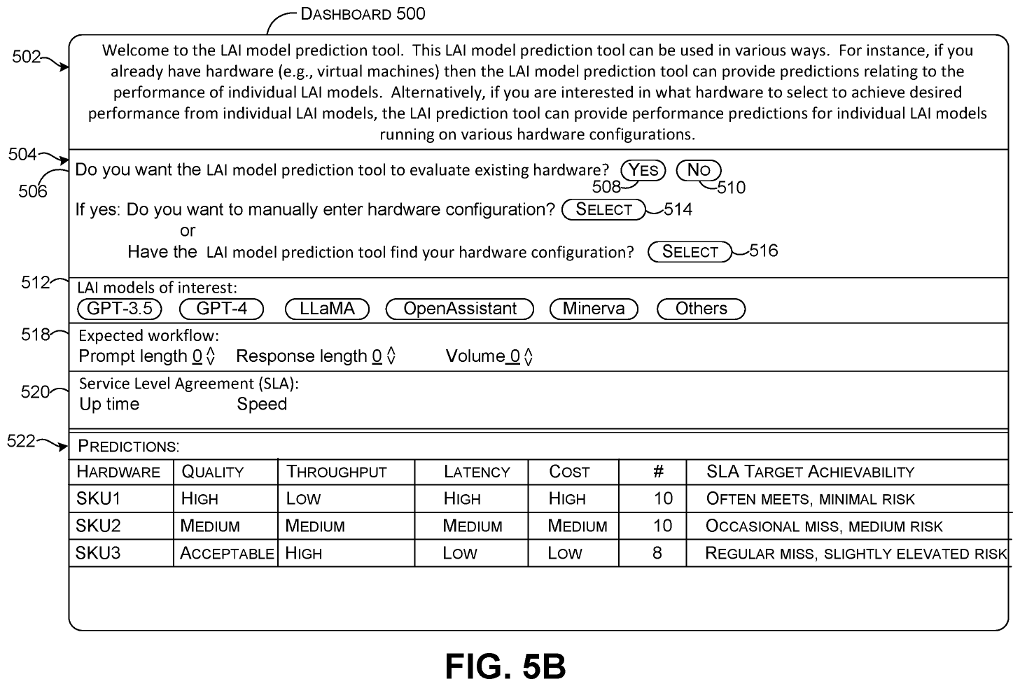

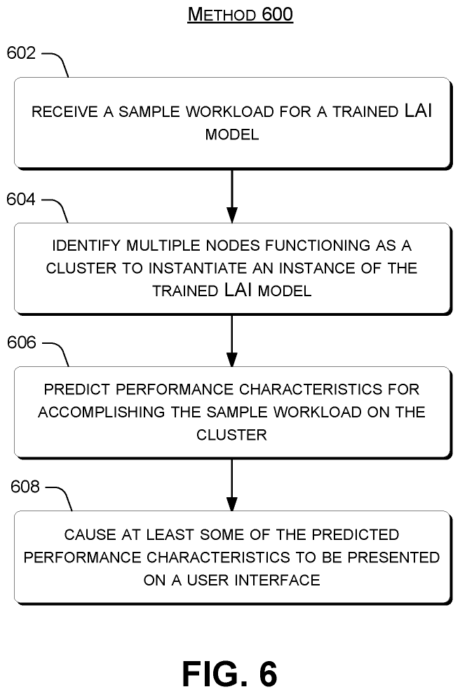

A sensitivity analysis can be conducted within the cost-SLA continuum here considering the hardware, LAI model, and quality of results in use. In certain cases, a lighter LAI model can be placed in production for inference needs, if the quality of results from such a model is acceptable. Hence, a matrix of LAI models and hardware SKUs and quality of results in the desired geo or region to achieve stated SLA with the performance-scale goals and a pricing sensitivity can be constructed with these results. This can be presented in an automated design that allows the entity to make a conscious decision while balancing appropriate tradeoff for their business. One such example is shown and discussed relative to FIG. 5B.

### Use Case Scenario

FIGS. 5A and 5B collectively show an example user interface in the form of a dashboard 500, which can implement the present LAI resource prediction concepts. FIG. 5A shows dashboard 500 where the customer/entity enters their information. FIG. 5B shows a subsequent dashboard 500 that shows the LAI resource prediction results associated with the customer's information. These dashboards illustrate some of the present concepts and many other dashboards and/or user interface configurations are contemplated.

In relation to FIG. 5A, the dashboard 500 includes a general information section 502 and an input section 504. In this example, the general information section 502 states “Welcome to the LAI model prediction tool. This LAI model prediction tool can be used in various ways. For instance, if you already have hardware (e.g., virtual machines) then the LAI model prediction tool can provide predictions relating to the performance of individual LAI models. Alternatively, if you are interested in what hardware to select to achieve desired performance from individual LAI models, the LAI prediction tool can provide performance predictions for individual LAI models running on various hardware configurations.”

Input section 504 asks the customer at 506 “Do you want the LAI model prediction tool to evaluate existing hardware?” The customer can select “Yes” at 508 of “No” at 510. If the user selects “No” at 510, they proceed to LAI models of interest at 512. The user may select “No” at 510 if they are using the LAI model prediction tool to select which hardware to purchase for their (future) needs.

If the user selects ‘Yes’ at 508 the user can select to manually enter the hardware configuration at 514 or to have the LAI model prediction tool find the hardware configuration at 516. For instance, the customer's account may indicate or be linked to information about the customer's hardware configuration (e.g., what SKUs the user has and how many of each SKU). For purposes of explanation, assume that in this example the user selects to have the LAI model prediction tool find the hardware configuration at 516. Further assume that the LAI model prediction tool finds three SKUs (e.g., SKU1, SKU2, and SKU3 and number of each SKU) associated with the user account. At this point, the user proceeds to LAI models of interest at 512.

At 512, the dashboard allows the customer the opportunity to select individual LAI models, such as GPT-3.5, GPT-4, LLAMA, OpenAssistant, Minerva, and/or others. It is contemplated that these LAI models will evolve over time and/or be replaced by newer models.

At 518, the dashboard 500 allows the customer to input expected workflow information. In this case, the expected workflow information relates to (expected or average) prompt length/size, desired response length, and volume (e.g., number of prompts per unit time). The customer can adjust these values up and down.

At 520, the dashboard allows the customer to input aspects relating to the service level agreement between the user/entity and their customers (e.g., the end users), such as up time, speed, etc.

FIG. 5B adds example prediction section 522 to the dashboard 500. In this example, the prediction section 522 includes a table with columns relating to hardware, quality, throughput, latency, cost, number (#), and SLA target achievability. Each row of the table relates to one of the customers hardware configurations (e.g., SKU1, SKU2, and SKU3). Thus, for a given LAI model or models, the table provides (predicted) performance comparisons and the number of the SKUs employed to achieve the performance given the workload. For example, SKU1 provides relatively high-quality results to user prompts, but the relatively high-quality results are associated with relatively low throughput, relatively high latency, and relatively high cost. This hardware configuration often meets the SLA terms. In contrast, SKU3 produces only acceptable quality, but achieves that quality with relatively high throughput, relatively low latency, and relatively low cost. This hardware configuration is less likely to satisfy the SLA terms. SKU2 falls between the extremes of SKU1 and SKU3.

Many ways of populating the prediction section 522 are contemplated beyond those illustrated in FIG. 5B. Given a customer sample workload the present concepts can predict performance for various hardware configurations. The performance can include throughput and latency curves for individual LAI models. The predictions can also include the amount or number of the hardware resources needed to accomplish the performance for the given workload. This information can be presented in any combination of text, formulas, graphs, etc.

Note that in this example, the user interface is a graphical user interface in the form of a dashboard. In other implementations, the user interface may take other form factors. For instance, the user interface may be audio based. Further, this example illustrates the present concepts in two dashboard sequences. In other cases, a single dashboard may be employed, or more than two dashboards may be employed. For instance, the dashboard may update responsive to answers to individual questions so that a large set of dashboards are presented as an iterative interactive process.

Several implementations are described in detail above. FIG. 6 shows a flowchart of another example method. At block 602, the method can receive a sample workload for a trained LAI model. For instance, the sample workload can include prompt (e.g., request) size to the LAI model and response size from the LAI model. The sample workload can also convey an expected or desired volume (e.g., a number of prompts and/or responses per unit time). Note that the term ‘trained LAI model’ is used to convey that this method is directed toward using the model more than training the model. However, it is recognized that the entity/customer may customize the model to their application with additional (specialized/customized) training.

At block 604, the method can identify multiple nodes functioning as a cluster to instantiate an instance of the trained LAI model. Individual nodes can entail a single physical computing device, multiple physical computing devices, a single virtual machine, multiple virtual machines, and/or portions of any of these. For example, a node can entail a single computing device that includes multiple GPUs. In some cases, multiple clusters are compared to one another. For instance, multiple nodes of a first hardware configuration (e.g., first SKU) can function as a first cluster. Multiple nodes of a second hardware configuration (e.g., second SKU) can function as a second cluster. The performance of the two clusters can be compared for one or more LAI models.

At block 606, the method can predict performance characteristics for accomplishing the sample workload on the cluster. In the hardware comparison example, prediction is performed for the first cluster and the second cluster. The prediction can include comparisons of relative latency, throughput, and cost for the first cluster and the second cluster. The performance characteristics can be viewed as performance scale metrics.

The performance characteristics can relate to processing rate, such as load rate and/or generation rate. The performance characteristics can also relate to SLA availability, such as success percentages and/or kernel errors, which can include CUDA errors and/or other errors, such as redistribution errors, timeout errors, etc. The performance characteristics can relate to responses per second in relation to concurrency. The performance characteristics can also relate to latency, such as time to first byte (TTFB), total duration, and/or forward pass duration. The performance characteristics can also relate to transaction processing system (TPS) per replica, context TPS, cache hit rate, and/or generated TPS. The performance characteristics can also relate to utilization, such as GPU utilization and/or token utilization in relation to KV blocks and/or max tokens. KV blocks are a way of storing Key and Value tensors in the self-attention layers in LLMs. The number of KV blocks directly relates to the max memory that is available to the model on the hardware it runs in order to process tokens. The performance characteristics can also relate to cost, such as cost per 1K requests and/or costs per 1M tokens, for instance.

At block 608, the method can cause at least some of the predicted performance characteristics to be presented on a user interface. For instance, the method can generate a table that compares a relative performance of the first cluster to a relative performance of the second cluster. In some configurations, the method entails presenting the user interface. In other cases, the user interface is sent to a device, such as a device belonging to a customer for presentation (e.g., one device generates content of the user interface that is ultimately presented to the entity on another computing device). Note also that this method could be used for managing the data center. For instance, the owner of the data center could supply the method with the LAI models and parameters that were trending with customers. The method could then predict what SKUs and in what numbers to purchase to meet the customer demand.

The order in which the disclosed methods are described is not intended to be construed as a limitation, and any number of the described acts can be combined in any order to implement the method, or an alternate method. Furthermore, the methods can be implemented in any suitable hardware, software, firmware, or combination thereof, such that a computing device can implement the method. In one case, the methods are stored on one or more computer-readable storage media as a set of instructions such that execution by a processor of a computing device causes the computing device to perform the method.

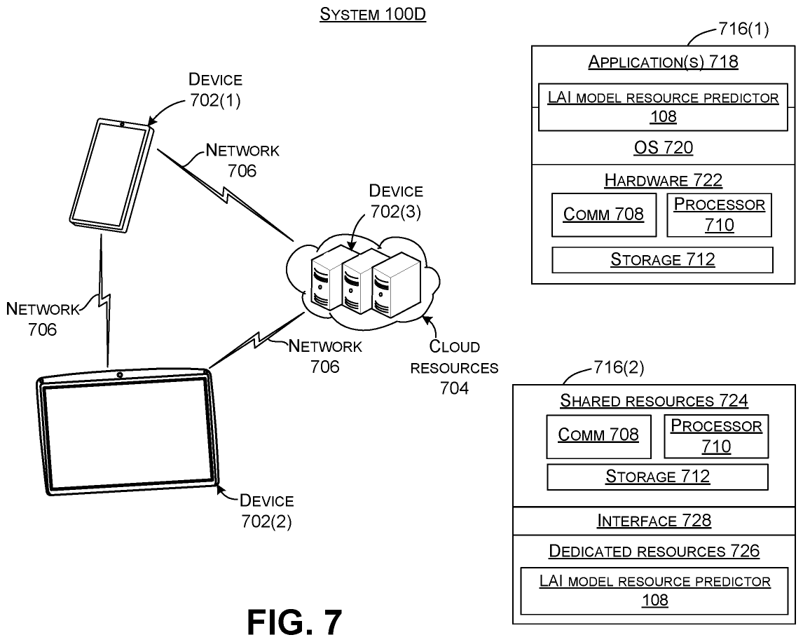

FIG. 7 shows an example system 100D. System 100D can include computing devices 702. Devices 702(1) and 702(2) are similar to device 124 of FIG. 1A. Similarly, device 702(3) is similar to device 104 of FIG. 1A. In the illustrated configuration, computing device 702(1) is manifest as a smartphone, computing device 702(2) is manifest as a tablet type device, and computing device 702(3) is manifest as a server type computing device, such as may be found in a datacenter as a cloud resource 704 (which is similar to cloud resources 102 of FIG. 1A). Computing devices 702 can be coupled via one or more networks 706 that are represented by lightning bolts. Networks 706 are similar to network 126 of FIG. 1A.

Computing devices 702 can include a communication component 708, a processor 710, storage resources (e.g., storage) 712, and/or LAI model resource predictor 108.

The LAI model resource predictor 108 can be configured to receive a sample workload for a trained LAI model, identify multiple nodes across which an instance of the trained LAI model is supported, and/or predict performance characteristics for accomplishing the sample workload across the multiple nodes.

The LAI model resource predictor 108 can predict resource (e.g., GPU) capacity requirements to achieve the desired SLA policy. The LAI model resource predictor 108 has the ability to compute cost from the performance curves described above relative to FIG. 4 and to forecast pricing for the consumer and the cloud-resources and long-term GPU capacity needs. The LAI model resource predictor 108 has the capability to abstract physical resources and networking topology to determine performance characteristics of LAI models. The LAI model resource predictor 108 provides a recommendation system consisting of a matrix of LLM models, hardware SKUs, quality of results in the desired geo/region to achieve stated SLA with the perf-scale-quality goals and a pricing sensitivity. The LAI model resource predictor 108 has the ability to understand the impact of different workloads on different LAIs without conducting extensive benchmarking or proof of concepts to get a rapid understanding of perf-scale-cost (what-if scenarios) under different quality considerations. The LAI model resource predictor 108 has the ability to model additional sensitivity analysis by adding information (such as expected cache hit rate, prompt customization etc.) that influences the token generation rate. The LAI model resource predictor 108 can entail an intelligent system that leverages the latency and throughput prediction for use at run time by observing a customer workload. It then ranks the LAI models and/or GPU cluster configurations to run this workload without any human intervention. It can determine the ideal model from the high ranking LAI models and/or GPU cluster configurations for the workload.

FIG. 7 shows two device configurations 716 that can be employed by computing devices 702. Individual computing devices 702 can employ either of configurations 716(1) or 716(2), or an alternate configuration. (Due to space constraints on the drawing page, one instance of each configuration is illustrated). Briefly, device configuration 716(1) represents an operating system (OS) centric configuration. Device configuration 716(2) represents a system on a chip (SOC) configuration. Device configuration 716(1) is organized into one or more applications 718, operating system 720, and hardware 722. Device configuration 716(2) is organized into shared resources 724, dedicated resources 726, and an interface 728 therebetween.

In configuration 716(1), the LAI model resource predictor 108 can be manifest as part of the operating system 720. Alternatively, the LAI model resource predictor 108 can be manifest as part of the applications 718 that operate in conjunction with the operating system 720 and/or processor 710. In configuration 716(2), the LAI model resource predictor 108 can be manifest as part of the processor 710 or a dedicated resource 726 that operates cooperatively with the processor 710.

In some configurations, each of computing devices 702 can have an instance of the LAI model resource predictor 108. However, the functionalities that can be performed by the LAI model resource predictors 108 may be the same or they may be different from one another when comparing computing devices. For instance, in some cases, each LAI model resource predictor 108 can be robust and provide all of the functionality described above and below (e.g., a device-centric implementation). In other cases, some devices can employ a less robust instance of the LAI model resource predictor 108 that relies on some functionality to be performed by another device. For example, the LAI model resource predictor 108 on device 702(1) or 702(2) may generate a user interface through which the user enters information. The LAI model resource predictor 108 on the cloud-resources 704 may make predictions relative to the user information, the model(s), and/or the user's cloud resources (e.g., SKUs), among other factors and send the predictions back to the original device for display to the user on the user interface.

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on/in storage, such as storage that can be internal or external to the device. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

As mentioned above, device configuration 716(2) can be thought of as a system on a chip (SOC) type design. In such a case, functionality provided by the device can be integrated on a single SOC or multiple coupled SOCs. One or more processors 710 can be configured to coordinate with shared resources 724, such as storage 712, etc., and/or one or more dedicated resources 726, such as hardware blocks configured to perform certain specific functionality. Thus, the term “processor” as used herein can also refer to central processing units (CPUs), graphical processing units (GPUs), field programmable gate arrays (FPGAs), controllers, microcontrollers, processor cores, hardware processing units, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU, CPUs, GPU or GPUs). The program code can be stored in one or more computer-readable memory devices, such as computer-readable storage media. The features and techniques of the components are platform-independent, meaning that they may be implemented on a variety of commercial computing platforms having a variety of processing configurations.

### Additional Examples

Various examples are described above. Additional examples are described below. One example includes a method comprising receiving a sample workload for a trained large artificial intelligence (LAI) model, identifying multiple nodes functioning as a cluster to instantiate an instance of the trained LAI model, predicting performance characteristics for accomplishing the sample workload on the cluster, and causing at least some of the predicted performance characteristics to be presented on a user interface.

Another example can include any of the above and/or below examples where the sample workload includes prompt size to the LAI model and response size from the LAI model.

Another example can include any of the above and/or below examples where the sample workload includes a number of prompts per unit time.

Another example can include any of the above and/or below examples where a node comprises a single physical computing device or wherein a node comprises a virtual machine.

Another example can include any of the above and/or below examples where predicting performance characteristics for accomplishing the sample workload on the cluster comprises predicting graphical processing unit (GPU) requirements to achieve performance associated with a service level agreement.

Another example can include any of the above and/or below examples where each node comprises multiple graphical processing units (GPUs).

Another example can include any of the above and/or below examples where identifying multiple nodes functioning as a cluster to instantiate an instance of the trained LGT model comprises identifying multiple nodes of a first hardware configuration functioning as a first cluster and multiple nodes of a second hardware configuration functioning as a second cluster.

Another example can include any of the above and/or below examples where predicting performance characteristics for accomplishing the sample workload is performed for the first cluster and the second cluster and includes comparisons of relative latency, throughput, and cost for the first cluster and the second cluster for the trained LAI model.

Another example can include any of the above and/or below examples where the predicting comprises predicting relative performance of the first cluster to a relative performance of the second cluster for the trained LAI model and predicting relative performance of the first cluster to a relative performance of the second cluster for a second trained LAI model.

Another example can include any of the above and/or below examples where the causing comprises generating a table that compares a relative performance of the first cluster to a relative performance of the second cluster for the trained LAI model.

Another example can include any of the above and/or below examples where the causing comprises presenting the predicted performance characteristics on the user interface or wherein the causing comprises sending the user interface to a device for presentation.

Another example can include any of the above and/or below examples where the trained LAI model comprises a trained large generative transformer (LGT) model.

Another example can include any of the above and/or below examples where the trained LGT model comprises a trained large language model (LLM).

Another example includes a system comprising a processor and a storage resource storing computer-readable instructions which, when executed by the processor, cause the processor to receive a sample workload for a trained large generative transformer (LGT) model, identify multiple nodes across which an instance of the trained LGT model is supported, and predict performance characteristics for accomplishing the sample workload across the multiple nodes.

Another example can include any of the above and/or below examples where the processor and storage are remote from the multiple nodes.

Another example can include any of the above and/or below examples where the system includes the multiple nodes or wherein the system communicates with the multiple nodes.

Another example can include any of the above and/or below examples where the processor is further configured to cause at least some of the predicted performance characteristics to be organized for presentation on a user interface.

Another example can include any of the above and/or below examples where the user interface comprises a matrix that compares multiple trained LGT models including the trained LGT model, and wherein the matrix includes hardware stock keeping units (SKUs) that can support the multiple nodes, quality of results in a desired region to achieve a desired service level agreement (SLA) with performance scale quality goals and pricing sensitivity.

Another example can include any of the above and/or below examples where the processor is further configured to present a sensitivity analysis that compares the trained LGT model to other trained LGT models for accomplishing the sample workload across the multiple nodes and compares pricing and service levels for each of the trained LGT models.

Another example can include any of the above and/or below examples where the sensitivity analysis reflects a token generation rate of the LGT models and includes a cache hit rate and/or prompt customization.

Another example can include any of the above and/or below examples where the processor is further configured to present the user interface or to send the user interface to a device for presentation and wherein the system includes the device or wherein the system does not include the device.

Another example can include any of the above and/or below examples where each node of the multiple nodes comprises a separate computing device from the other nodes.

Another example includes a computing device comprising hardware and a large generative transformer model resource predictor configured to receive a sample workload for a trained large artificial intelligence (LAI) model, identify multiple nodes across which an instance of the trained LAI model is supported, and predict performance characteristics for accomplishing the sample workload across the multiple nodes.

Another example can include any of the above and/or below examples where the large generative transformer model resource predictor is configured to predict performance characteristics as performance curves and to forecast pricing for accomplishing the sample workload at various points on the performance curves.

Another example can include any of the above and/or below examples where predicting performance characteristics include latency and throughput predictions and the large generative transformer model resource predictor is configured to determine a high-ranking LAI model and cluster configuration to run the sample workload.

Another example includes a system, comprising hardware and a large artificial intelligence (LAI) model resource predictor configured to receive a sample workload for a trained LAI model that is spread across multiple nodes, identify a first hardware configuration that can include the multiple nodes and a second hardware configuration that can include the multiple nodes, and predict performance characteristics for accomplishing the sample workload with the first hardware configuration and the second hardware configuration.

### CONCLUSION

The description includes novel LAI model resource prediction concepts. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
receiving a sample workload for a trained large artificial intelligence (LAI) model;
identifying multiple nodes functioning as a cluster to instantiate an instance of the trained LAI model;
predicting performance characteristics for accomplishing the sample workload on the cluster; and,
causing at least some of the predicted performance characteristics to be presented on a user interface.

2. The method of claim 1, wherein the sample workload includes prompt size to the LAI model and response size from the LAI model.

3. The method of claim 2, wherein the sample workload includes a number of prompts per unit time.

4. The method of claim 1, wherein a node comprises a single physical computing device or wherein a node comprises a virtual machine.

5. The method of claim 1, wherein predicting performance characteristics for accomplishing the sample workload on the cluster comprises predicting graphical processing unit (GPU) requirements to achieve performance associated with a service level agreement.

6. The method of claim 1, wherein each node comprises multiple graphical processing units (GPUs).

7. The method of claim 1, wherein identifying multiple nodes functioning as a cluster to instantiate an instance of the trained LAI model comprises identifying multiple nodes of a first hardware configuration functioning as a first cluster and multiple nodes of a second hardware configuration functioning as a second cluster.

8. The method of claim 7, wherein predicting performance characteristics for accomplishing the sample workload is performed for the first cluster and the second cluster and includes comparisons of relative latency, throughput, and cost for the first cluster and the second cluster for the trained LAI model.

9. The method of claim 8, wherein the predicting comprises predicting relative performance of the first cluster to a relative performance of the second cluster for the trained LAI model and predicting relative performance of the first cluster to a relative performance of the second cluster for a second trained LAI model.

10. The method of claim 8, wherein the causing comprises generating a table that compares a relative performance of the first cluster to a relative performance of the second cluster for the trained LAI model.

11. The method of claim 1, wherein the causing comprises presenting the predicted performance characteristics on the user interface or wherein the causing comprises sending the user interface to a device for presentation.

12. A system comprising:
a processor; and
a storage resource storing computer-readable instructions which, when executed by the processor, cause the processor to:
receive a sample workload for a trained large generative transformer (LGT) model;
identify multiple nodes across which an instance of the trained LGT model is supported; and,
predict performance characteristics for accomplishing the sample workload across the multiple nodes.

13. The system of claim 12, wherein the processor and storage are remote from the multiple nodes.

14. The system of claim 12, wherein the system includes the multiple nodes or wherein the system communicates with the multiple nodes.

15. The system of claim 12, wherein the processor is further configured to cause at least some of the predicted performance characteristics to be included on a user interface.

16. The system of claim 15, wherein the user interface comprises a matrix that compares multiple trained LGT models including the trained LGT model, and wherein the matrix includes hardware stock keeping units (SKUs) that can support the multiple nodes, quality of results in a desired region to achieve a desired service level agreement (SLA) with performance scale quality goals and pricing sensitivity.

17. The system of claim 15, wherein the processor is further configured to present a sensitivity analysis that compares the trained LGT model to other trained LGT models for accomplishing the sample workload across the multiple nodes and compares pricing and service levels for each of the trained LGT models.

18. The system of claim 17, wherein the sensitivity analysis includes a token generation rate of the trained LGT models and includes a cache hit rate and/or prompt customization.

19. The system of claim 17, wherein the processor is further configured to present the user interface or to send the user interface to a device for presentation and wherein the system includes the device or wherein the system does not include the device.

20. A system, comprising:
hardware; and,
a large artificial intelligence (LAI) model resource predictor configured to receive a sample workload for a trained LAI model that is spread across multiple nodes, identify a first hardware configuration that can include the multiple nodes and a second hardware configuration that can include the multiple nodes, and predict performance characteristics for accomplishing the sample workload with the first hardware configuration and the second hardware configuration.
